(19) United States
(12) Patent Application Publication
(10) Pub. No.: US 2023/0264675 A1
(43) Pub. Date: Aug. 24, 2023

(54) METHOD AND SYSTEM FOR ENERGY MANAGEMENT OF A MOTOR VEHICLE CARRYING A CONTAINER POWERED BY AN AUXILIARY POWER UNIT

(71) Applicants: Hyundai Motor Company, Seoul (KR); Kia Corporation, Seoul (KR)

(72) Inventors: Andreas Kapp, Eschborn (DE); Carsten Loevenich, Oberstenfeld (DE); Sebastian Martin, Fulda (DE); Yannick Port, Limeshain (DE); Ulrich Karrer, Main (DE); Stephan Revidat, Langen (DE)

(21) Appl. No.: 17/903,718

(22) Filed: Sep. 6, 2022

(30) Foreign Application Priority Data
Feb. 21, 2022 (DE) 102022201750.1

(51) Int. Cl. B60W 20/10; B60W 10/30; B60W 10/06; B60W 10/08

(52) U.S. Cl. CPC B60W 20/10; B60W 10/30; B60W 10/06; B60W 10/08; B60W 2400/00

(57) ABSTRACT

A method for energy management of a motor vehicle carrying a container powered by an auxiliary power unit is provided. The method comprises determining total energy resources available on the motor vehicle for propulsion of the motor vehicle and for powering the container; determining a first energy fraction of the total energy resources required to power the container with the auxiliary power unit along a route of the motor vehicle; determining a second energy fraction of the total energy resources required to power at least one main motor of the motor vehicle to reach a target destination with the motor vehicle along the route of the motor vehicle; and reallocating at least a fraction of the total energy resources from the auxiliary power unit to the at least one main motor of the motor vehicle or vice versa depending on the first energy fraction and the second energy fraction.

### CROSS REFERENCE TO RELATED APPLICATION

The present application is based on and claims the benefit of a German Patent Application No. 102022201750.1 filed on Feb. 21, 2022, the entire contents of which are incorporated herein for all purposes by this reference.

### TECHNICAL FIELD

Embodiments of the present disclosure pertain to a method and a system for energy management of a motor vehicle carrying a container powered by an auxiliary power unit. Embodiments of the disclosure further pertain to a motor vehicle having such a system.

### BACKGROUND

Because of a combination of factors, such as environmental concerns, high oil prices and the potential for peak oil, development of cleaner alternative fuels and advanced power systems for vehicles has become a high priority for many governments and vehicle manufacturers around the world. Various solutions for vehicles running on alternative fuels have thus been increasingly contemplated in recent years. One particular example in this respect are hydrogen vehicles, which use hydrogen fuel for motive power. Such vehicles typically convert the chemical energy of hydrogen to mechanical energy either by burning hydrogen in an internal combustion engine or by reacting hydrogen with oxygen in a fuel cell to power electric motors.

In principle, hydrogen vehicles can be refilled at hydrogen refueling stations much in the same way as petroleum or other fuels can be refilled at a gas station. However, hydrogen fuel stations are nowadays still rather limited, a nationwide hydrogen infrastructure being one challenge for the future. In this regard, limp-home functionalities would ensure that vehicles are able to reach the next (available) hydrogen fuel station. Increasing the possible mileage would also be helpful as a safety and comfort measure in cases of emergency.

Especially for heated/cooled cargo trucks carrying temperature-controlled containers and having to deliver goods in time, reaching the targeted destination may be vital. These kinds of trucks usually carry a container (either directly and/or by means of a trailer with the container on it), which is powered by an auxiliary power unit, that is, a device providing energy for functions other than propulsion. More specifically, they are usually equipped with either a generator (typically still diesel based, but hydrogen and other alternative fuels offer attractive alternatives) or a dedicated electric battery (this variant is increasingly used in recent years). Nowadays calculation of routes based on real time data is possible, but with the limited distribution of alternative fuel stations and/or taking possible unexpected occurrences into account, it would be desirable if the mileage of such trucks could be increased at short notice during operation to avoid any undesired stop.

The reference U.S. Pat. No. 9,481,354 B2 describes emergency operation methods for hybrid vehicles.

### SUMMARY

According to one embodiment of the disclosure, a method for energy management of a motor vehicle carrying a container powered by an auxiliary power unit comprises determining total energy resources available on the motor vehicle for propulsion of the motor vehicle and for powering the container; determining a first energy fraction of the total energy resources required to power the container with the auxiliary power unit along a route of the motor vehicle; determining a second energy fraction of the total energy resources required to power at least one main motor of the motor vehicle to reach a target destination with the motor vehicle along the route of the motor vehicle; and reallocating at least a fraction of the total energy resources from the auxiliary power unit to the at least one main motor of the motor vehicle or vice versa depending on the first energy fraction and the second energy fraction.

According to another embodiment of the disclosure, a system for energy management of a motor vehicle carrying a container powered by an auxiliary power unit comprises at least one main engine for propelling the motor vehicle; an auxiliary power unit for powering the container; and an energy management controller configured to determine total energy resources available on the motor vehicle for propulsion of the motor vehicle and for powering the container, to determine a first energy fraction of the total energy resources required to power the container with the auxiliary power unit along a route of the motor vehicle, to determine a second energy fraction of the total energy resources required to power the at least one main motor of the motor vehicle to reach a target destination with the motor vehicle along the route of the motor vehicle, and to reallocate at least a fraction of the total energy resources of the auxiliary power unit to the at least one main motor of the motor vehicle or vice versa depending on the first energy fraction and the second energy fraction.

According to yet another embodiment of the disclosure, a motor vehicle comprises a system according to the disclosure.

One idea of the present disclosure is to redirect at least a fraction of the energy originally intended for either powering the container or propelling the motor vehicle and allocate it for the respective other purpose under certain circumstances. Based on this kind of energy management across commonly separated systems, the operation of a motor vehicle transporting heated or cooled goods may be improved, in particular in case that the energy reserves of one of the respective systems become scarce. Embodiments of the present disclosure are based on the insight that cargo trucks usually carry at least two sources of energy originally reserved for different purposes, which in principle however could be also utilized for the respective other purpose. For example, electric energy stored in a battery of a container unit could also be used to power an electric motor of the vehicle's propulsion system and vice versa. Moreover, fuel originally reserved for powering a generator unit may also be used to drive an internal combustion engine and vice versa.

For example, if a truck running on hydrogen and carrying a cooling container is about to run out of fuel and a fuel station cannot be reached anymore based on the hydrogen reserves in the truck's tank, the energy of the cooling container, e.g., electric energy of a container battery or hydrogen fuel of a generator set, can be used to extend the driving range of the truck such that the vehicle is able to reach the next fuel station and/or an alternative closer destination.

Alternatively, available energy can also be moved from the propulsion system of the vehicle to the auxiliary power unit of the container. For example, the system may determine that the energy originally reserved for the auxiliary power unit is not sufficient to power the container until the scheduled destination. In that case, energy from the propulsion system, e.g., electric energy of a traction battery, may be redirected to the auxiliary power unit to save the transported goods until the vehicle reaches its destination, or at least until it reaches a refueling station. If the total energy reserves drop below a critical value, the vehicle may even be stopped such that any residual energy may be used to power the container to be able to salvage the goods in an adequate condition at a later point in time.

Advantageous embodiments and improvements of the present disclosure are found in the subordinate claims.

According to an exemplary embodiment of the disclosure, the energy management controller may be configured to reallocate the energy resources from the auxiliary power unit to the at least one main motor in case that the motor vehicle would otherwise not be able to reach the target destination.

Hence, in this embodiment, at least a fraction of the energy intended for powering the container is used to support the propulsion system of the motor vehicle instead. There are various ways in which this reallocation of the available energy can be implemented. In one example, the propulsion system of the motor vehicle may be supplied with hydrogen from a container generator unit to supply a fuel cell and/or an internal combustion engine running on hydrogen. In another example, a traction battery of the motor vehicle may be fed with electrical power stemming from the auxiliary power unit of the container, e.g., directly from a battery employed there or by first burning fuel in a generator unit of the container.

According to an exemplary embodiment of the disclosure, the energy management controller may be configured to change the target destination to an alternative target destination and/or a reachable filling station in case that the target destination cannot be reached even by reallocating the energy resources from the auxiliary power unit.

The motor vehicle may comprise a control unit that constantly evaluates the available and required energy portions for the respective vehicle systems and may then decide depending on the outcome of its calculations that a scheduled target cannot be reached anymore due to changed circumstances. For example, an originally scheduled destination may not be reachable anymore because a fuel station on the way is unexpectedly closed or out of service, which originally was taken into account as potential refueling station for the vehicle.

According to an exemplary embodiment of the disclosure, the energy management controller may be configured to issue a request or command to stop the motor vehicle in case that the total energy resources are required to power the container with the auxiliary power unit.

Hence, a motor vehicle may be stopped and all available energy may be used to keep the goods cooled (and/or heated) and in good conditions. All available energy may be transferred from the propulsion system to the container to keep the goods under optimal conditions as long as possible/necessary. The vehicle's system may issue an emergency call for refueling the vehicle at the current position or may ask the operator to make such a call.

According to an exemplary embodiment of the disclosure, the energy management controller may be configured to reallocate at least a fraction of the total energy resources by redirecting fuel and/or electric energy between the auxiliary power unit and the at least one main engine of the motor vehicle.

Hence, in one example, the power train of the motor vehicle may receive fuel, e.g., hydrogen, directly from the container system instead of the normal fuel tank of the vehicle, e.g., from a dedicated hydrogen fuel tank of a container generator. In another example, a traction battery of the motor vehicle may be supplied with electric energy coming from the container's generator system (e.g., a generator based on diesel or an alternative fuel) and/or from an electric battery normally supplying the container.

According to an exemplary embodiment of the disclosure, the redirected fuel may comprise hydrogen.

Even though hydrogen powered motor vehicles are up to now rarely available on the road (fuel cell as well as internal combustion based), their number keeps increasing. At the moment, there are mainly two filling pressures in common use around the world, namely H70 or 700 bar on the one hand and the older standard H35 or 350 bar on the other. Independent of the respective system, all of such vehicles are equipped with high pressure (350 bar or 700 bar) hydrogen tanks according to international standards, e.g., located behind the driver cabinet in case of semi-trailer trucks. In the future also liquefied H2 or compressed liquefied H2 are energy sources for a CO2 neutral transportation as some vehicle manufacturer favors these in line with higher energy density (J/m³).

In a similar vein, diesel powered generator sets of refrigerated containers may be replaced by ecofriendly technologies, in particular hydrogen-based fuel cells or generators. The respective container may then also be equipped with a dedicated hydrogen system, in particular a dedicated hydrogen tank. The hydrogen stored on such a vehicle may hence be used not only to feed the propulsion system of the motor vehicle but also to supply the auxiliary power unit of the container. Based on the same international standards of the hydrogen fuel tanks, an exchange of hydrogen from such a powered container to the vehicle's fuel tanks (or vice versa) is technically possible. In that vein even a leakage of the hydrogen tank at the cooling container could be overbridged by redirecting hydrogen from the main fuel tank of the vehicle.

To this end, one or several pressure control valves may be provided on the vehicle to enable the hydrogen exchange through flexible tubes.

According to an exemplary embodiment of the disclosure, the auxiliary power unit may be configured to provide its power to heat or refrigerate the container.

Hence, the powered container may particularly be a refrigerated or heated container, e.g., for delivery of food, medicine etc.

As discussed, the method and system suitably include use of a controller or processer.

In another aspect, vehicles are provided that comprise an apparatus as disclosed herein.

Embodiments of the present disclosure will be explained in greater detail with reference to exemplary embodiments depicted in the drawings as appended.

### BRIEF DESCRIPTION OF DRAWINGS

It is understood that the term “vehicle” or “vehicular” or other similar term as used herein is inclusive of motor vehicles in general such as passenger automobiles including sports utility vehicles (SUV), buses, trucks, various commercial vehicles, and the like, and includes hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Further, the control logic of embodiments of the present disclosure may be embodied as non-transitory computer readable media on a computer readable medium containing executable program instructions executed by a processor, controller, or the like. Examples of computer readable media include, but are not limited to, ROM, RAM, compact disc (CD)-ROMs, magnetic tapes, floppy disks, flash drives, smart cards, and optical data storage devices. The computer readable medium can also be distributed in network coupled computer systems so that the computer readable media is stored and executed in a distributed fashion, e.g., by a telematics server or a Controller Area Network (CAN).

The accompanying drawings are included to provide a further understanding of the present disclosure and are incorporated in and constitute a part of this specification. The drawings illustrate the embodiments of the present disclosure and together with the description serve to explain the principles of embodiments of the present disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically shows a motor vehicle having a system for energy management according to an exemplary embodiment of the disclosure.

FIG. 2 schematically shows a system for energy management according to an exemplary embodiment of the disclosure as it can be used in the vehicle of FIG. 1.

FIG. 3 schematically shows a system for energy management according to an alternative embodiment of the disclosure as it can be used in the vehicle of FIG. 1.

FIG. 4 shows a flow diagram of a method for energy management of the motor vehicle of FIG. 1.

Although specific embodiments are illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION

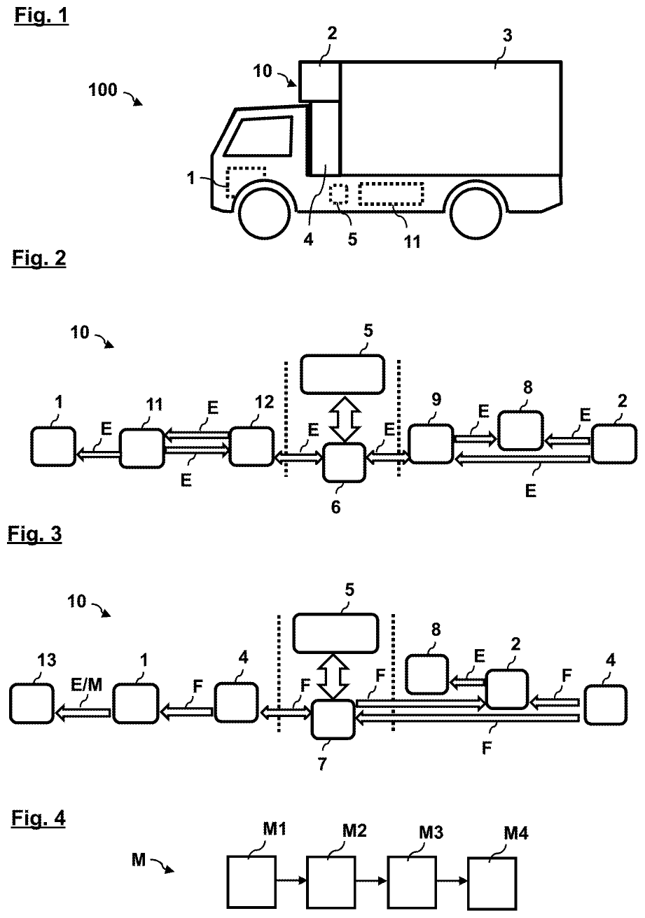

FIG. 1 schematically shows a motor vehicle 100 having a system 10 for energy management according to an exemplary embodiment of the disclosure. Two exemplary embodiments of such systems 10 are schematically depicted in FIGS. 2 and 3 in more detail. FIG. 4 finally shows a flow diagram of a method M for energy management of the motor vehicle of FIG. 1.

The vehicle 100 of this embodiment may be, for example, a bus, truck, or other commercial vehicle running on ecofriendly energy sources as its primary source of power for locomotion.

In one particular exemplary embodiment, the vehicle 100 may be an electric vehicle having a traction battery 11 supplying a main motor 1 with electric energy.

In another exemplary embodiment, the vehicle 100 may be a hydrogen internal combustion engine vehicle (HICEV), which is a modified version of the traditional gasoline-powered internal combustion engine and which combusts hydrogen instead of gasoline in its internal combustion engine. The main motor 1 in this case would be a hydrogen-based internal combustion engine, which may be supplied by a fuel tank 4 storing gaseous hydrogen. Such a hydrogen tank 4 may comply with the common high pressure standards of 350 bar or 700 bar and may be arranged behind a driver cabinet of the vehicle 100, for example.

Alternatively, the vehicle 100 may also rely on fuel-cell conversion, in which the hydrogen is turned into electricity through fuel cells which then power an electric motor as main motor 1. With either method, the only byproduct from the spent hydrogen is water, and the process is entirely free of CO2 emissions, which is one reason why hydrogen is a particularly attractive alternative fuel.

In other exemplary embodiments, the vehicle 100 may feature a hybrid power train comprising two or more main motors 1, e.g., an electric motor and a hydrogen burning internal combustion engine. It is further to be understood that other conventional or alternative fuels may be used in other embodiments, e.g., natural gas, liquefied natural gas, liquefied petroleum gas and so on.

The depicted motor vehicle 100 may further comprise a refrigerated container 3 that is powered by an auxiliary power unit 2 and configured to transport cooled goods, e.g., food or medicine. The auxiliary power unit 2 may be run on ecofriendly fuels, e.g., hydrogen, and/or may receive its electric power from a dedicated electric battery (not shown). In this sense the fuel tank 4 shown in FIG. 1 may also represent a fuel tank 4 of the auxiliary power unit 2 that is attached to and/or integrated in the auxiliary power unit 2 and/or the container 3. More generally, the vehicle 100 may comprise several fuel tanks 4, e.g., one fuel tank for the propulsion system (e.g., common diesel or hydrogen) and one fuel tank for the container 3 (e.g., also diesel or hydrogen).

Nowadays, commercial vehicles running on electricity and/or hydrogen often struggle with their maximum driving range in order to deliver and supply their partners with the loaded goods. When focusing on the cargo trucks with additional cooling trailers for cold stored goods, the importance of delivery becomes even more vital. For that reason, the coolant truck container and/or trailer usually already operates under additionally available energy provided by an auxiliary power unit based on, for example, hydrogen, battery electric energy or electric energy produced by a diesel generator.

In order to keep such a vehicle 100 from running out of fuel due to unexpected circumstances (e.g., traffic, rerouting, unavailability of refueling infrastructure, etc.), additional usage of the available energy from the coolant truck trailer/container can be utilized for special emergency cases.

To overcome these issues, the present system 10 of the exemplary embodiments of FIGS. 2 and 3 is provided for energy management of the motor vehicle 100 in order to increase its range and flexibility, in particular for last mileage driving, as will be explained in the following. The underlying idea is to keep transported goods cooled in any situation and/or to avoid a breakdown of the vehicle in case it runs out of fuel and/or electric energy stored in its propulsion system.

To achieve this, not only the energy resources of the propulsion system are considered (e.g., electricity of a traction battery and/or hydrogen in a normal fuel tank), but in addition also the available energy resources of the cooling container 3 are taken into account. Overall energy usage and distribution is then controlled by an energy management controller 5 taking all relevant and important information into account.

More specifically, the energy management controller 5 may be configured to determine total energy resources available on the motor vehicle 100 for propulsion of the motor vehicle 100 and for powering the container 3. For example, the energy management controller 5 may calculate the available fuel and/or electricity in the propulsion system as well as in the container system (filling status of fuel tanks, battery status etc.).

The energy management controller 5 may be further configured to determine a first energy fraction of the total energy resources required to power the container 3 with the auxiliary power unit 2 along a route of the motor vehicle 100. To this end, various parameters may be taken into account comprising but not limited to required cooling temperature, environmental temperature, weather conditions, cooling parameters of the freight, e.g., weight, and so on.

The energy management controller 5 may be further configured to determine a second energy fraction of the total energy resources required to power the at least one main motor 1 of the motor vehicle 100 to reach a target destination with the motor vehicle 100 along the route of the motor vehicle 100. The controller 5 may thus be communicatively coupled to or integrated with a navigation system of the vehicle 100 in order to gain additional/mandatory access information about the specific route including distance, altitude profile, traffic situation, weather forecast, legal requirements, e.g., environmental zones in a city, and so on.

Finally, the energy management controller 5 may be configured to reallocate at least a fraction of the total energy resources of the auxiliary power unit 2 to the at least one main motor 1 of the motor vehicle 100 or vice versa depending on the first energy fraction and the second energy fraction. The result may be influenced by various calculation parameters, constraints and/or priorities. For example, the highest priority may be placed on proper temperature control of the freight.

To this end, the energy management controller 5 may utilize a smart cost function that relies on real-time data input, e.g., distances to destinations and fuel stations, the traffic situation and so on, to decide whether it is more important that the vehicle 100 reaches its original (or a new alternative) destination or whether the highest priority lies on optimal storage of the goods.

The corresponding method M of FIG. 4 thus comprises under M1 determining the total energy resources available on the motor vehicle 100 for propulsion of the motor vehicle 100 and for powering the container 3, under M2 determining the first energy fraction of the total energy resources required to power the container 3 with the auxiliary power unit 2 along a route of the motor vehicle 100, under M3 determining the second energy fraction of the total energy resources required to power at least one main motor 1 of the motor vehicle 100 to reach a target destination with the motor vehicle 100 along the route of the motor vehicle 100, and under M4 reallocating at least a fraction of the total energy resources from the auxiliary power unit 2 to the at least one main motor 1 of the motor vehicle 100 or vice versa depending on the first energy fraction and the second energy fraction.

Based on the strategy of the controller 5, the following exemplary energy transfers may be taken into consideration:

In one example, the energy resources may be reallocated from the auxiliary power unit 2 to the at least one main motor 1 in case that the motor vehicle 100 would otherwise not be able to reach the target destination. To this end, fuel and/or electric energy may be redirected from the auxiliary power unit 2 to the at least one main engine 1 of the motor vehicle 100. For example, hydrogen fuel may be rerouted from the auxiliary power unit 2 to a main motor 1 of the vehicle 100 for propulsion. Similarly, electric power may be provided by the auxiliary power unit 2, e.g., from a dedicated battery and/or by burning fuel in a generator unit.

In case that the target destination cannot be reached even by reallocating the energy resources from the auxiliary power unit 2, the scheduled target may be changed to an alternative target destination and/or a reachable filling station where the fuel tank(s) 4 of the vehicle 100 may be refilled.

In another example, the controller 5 may decide to issue a request or command to stop the motor vehicle 100 in case that the total energy resources are required to power the container 3 with the auxiliary power unit 2. The operator of the vehicle 100 may then make a call for on-road emergency support. Alternatively, the vehicle 100 may send out such a call automatically. All available energy may then be used to keep the goods cooled and in good condition by transferring all available energy from the propulsion system of the vehicle 100 to the auxiliary power unit 2 of the container 3 to keep the goods cooled as long as possible/necessary.

In the exemplary embodiment shown in FIG. 2, a voltage converter 6 (e.g., an AC-DC-Converter) may be controlled by the energy management controller 5 to adapt the voltage levels between the auxiliary power unit 2 and the main motor of propulsion system of the system 10, e.g., an electric motor, in order to transfer electric energy between both portions of the system 10 (the arrows in FIG. 2 indicating transfer of electric energy E between the respective components of the system 10).

Typical long-haul trucks already have several standard connectors between truck and trailer, such as pressurized air (for braking system), electric supply (low voltage) for trailer (backlight, braking lights etc.) or a hydraulic connection (pressurized oil, e.g., for lifting function of the trailer). Typical cooling containers on the market are already equipped with electric power plugs (for power supply on ships, in harbors etc.). If such a container is furthermore using a generator set, electric energy can also be transferred from the container to a truck. Battery electric vehicles or plug-in hybrid electric vehicles also already have a power plug connection to charge the battery, thereby the principal infrastructure within a truck is often given. Existing infrastructure to connect cooling container and truck may also be fundamentally given, combining the infrastructure of both may only require a connection of the different power levels (e.g., AC at cooling trailer and DC at truck) and a controller for the overall energy management.

In the exemplary embodiment of FIG. 3, a control valve 7 may be controlled by the energy management controller 5 to transfer hydrogen (or other fuel) between one main motor 1 and the auxiliary power unit 2. In this case, the arrows indicate either transfer of fuel F or of electric/mechanical energy E/M between the respective components of the system 10. As can be seen in FIG. 3, two fuel tanks 4 may be provided, one for the propulsion system of the vehicle 100 and one for the auxiliary power unit 2.

In the foregoing detailed description, various features are grouped together in one or more examples with the purpose of streamlining the present disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The embodiments were chosen and described in order to explain the principles of the present disclosure and its practical applications, to thereby enable others skilled in the art to utilize the present disclosure and various embodiments with various modifications as are suited to the particular use contemplated.

What is claimed is:

1. A method for energy management of a motor vehicle carrying a container powered by an auxiliary power unit, the method comprising:
determining total energy resources available on the motor vehicle for propulsion of the motor vehicle and for powering the container;
determining a first energy fraction of the total energy resources required to power the container with the auxiliary power unit along a route of the motor vehicle;
determining a second energy fraction of the total energy resources required to power at least one main motor of the motor vehicle to reach a target destination with the motor vehicle along the route of the motor vehicle; and
reallocating at least a fraction of the total energy resources from the auxiliary power unit to the at least one main motor of the motor vehicle or vice versa depending on the first energy fraction and the second energy fraction.

2. The method according to claim 1, wherein the energy resources are reallocated from the auxiliary power unit to the at least one main motor in case that the motor vehicle would otherwise not be able to reach the target destination.

3. The method according to claim 1, wherein the target destination is changed to an alternative target destination and/or a reachable filling station in case that the target destination cannot be reached even by reallocating the energy resources from the auxiliary power unit.

4. The method according to claim 1, wherein a request or command to stop the motor vehicle is issued in case that the total energy resources are required to power the container with the auxiliary power unit.

5. The method according to claim 1, wherein reallocating at least a fraction of the total energy resources comprises redirecting fuel and/or electric energy between the auxiliary power unit and the at least one main engine of the motor vehicle.

6. The method according to claim 1, wherein the redirected fuel comprises hydrogen.

7. The method according to claim 1, wherein the auxiliary power unit provides its power to heat or refrigerate the container.

8. A system for energy management of a motor vehicle carrying a container powered by an auxiliary power unit, the system comprising:
at least one main engine for propelling the motor vehicle;
an auxiliary power unit for powering the container; and
an energy management controller configured to:
determine total energy resources available on the motor vehicle for propulsion of the motor vehicle and for powering the container
determine a first energy fraction of the total energy resources required to power the container with the auxiliary power unit along a route of the motor vehicle
determine a second energy fraction of the total energy resources required to power the at least one main motor of the motor vehicle to reach a target destination with the motor vehicle along the route of the motor vehicle, and
reallocate at least a fraction of the total energy resources of the auxiliary power unit to the at least one main motor of the motor vehicle or vice versa depending on the first energy fraction and the second energy fraction.

9. The system according to claim 8, wherein the energy management controller is configured to reallocate the energy resources from the auxiliary power unit to the at least one main motor in case that the motor vehicle would otherwise not be able to reach the target destination.

10. The system according to claim 8, wherein the energy management controller is configured to change the target destination to an alternative target destination and/or a reachable filling station in case that the target destination cannot be reached even by reallocating the energy resources from the auxiliary power unit.

11. The system according to claim 8, wherein the energy management controller is configured to issue a request or command to stop the motor vehicle in case that the total energy resources are required to power the container with the auxiliary power unit.

12. The system according to claim 8, wherein the energy management controller is configured to reallocate at least a fraction of the total energy resources by redirecting fuel and/or electric energy between the auxiliary power unit and the at least one main engine of the motor vehicle.

13. The system according to claim 8, wherein the redirected fuel comprises hydrogen.

14. The system according to claim 8, wherein the auxiliary power unit is configured to provide its power to heat or refrigerate the container.

15. A motor vehicle with the system according to claim 8.
